(19) United States
(12) Patent Application Publication
(10) Pub. No.: US 2025/0005218 A1
(43) Pub. Date: Jan. 2, 2025

(54) Method, Device, Vehicle and Computer Program for Modeling and Monitoring a Warming-Up Behavior of a Vehicle Component

(71) Applicant: Bayerische Motoren Werke Aktiengesellschaft, Muenchen (DE)

(72) Inventors: Andreas Haertl, Neuried (DE); Peter Herbst, Muenchen (DE)

(21) Appl. No.: 18/563,342

(22) PCT Filed: Jan. 18, 2022
(86) PCT No.: PCT/EP2022/050949

§ 371 Date: Nov. 21, 2023

(30) Foreign Application Priority Data
Jun. 11, 2021 (DE) 10 2021 115 103.1

(51) Int. Cl. G06F 30/15

(52) U.S. Cl. CPC G06F 30/15

(57) ABSTRACT

A method for modeling a warming-up behavior of a vehicle component includes detecting a plurality of input variables and obtaining warming-up curves during a plurality of warming-up processes of the vehicle component. The method also includes creating a white box model based on items of information with respect to at least one of the plurality of input variables, and training and validating a black box model based on items of information comprising at least one output variable of the white box model and at least one of the warming-up curves. The method further includes modeling a warming-up behavior of the vehicle component using a gray box model formed of the white box model and the black box model.

The present application is the U.S. national phase of PCT Application PCT/EP2022/050949 filed on Jan. 18, 2022, which claims priority of German patent application No. 102021115103.1 filed on Jun. 11, 2021, which is incorporated herein by reference in its entirety.

### TECHNICAL FIELD

The disclosure relates to vehicles, and more particularly, to modeling a warming-up behavior of a vehicle component.

### BACKGROUND

Modeling and monitoring a warming-up behavior of components in a vehicle is an important part of the diagnosis and checking of correct functionality of such a component. Presently, such warming-up behaviors are modeled based on statistical reference curves. For example, when checking whether a vehicle engine warms up fast enough, it is of great importance for a model which is reliable and as accurate as possible to be provided, also for providing evidence to authorities.

Disadvantages of the currently used statistical models are, for example, that they are based on “worst-case” scenarios in order to guarantee sufficient security with respect to legal requirements. This results in a high level of expenditure and can result in unjustified error messages. If such an inaccurate model is used in an OBD system, in the worst case this can result in a bad user experience. In addition, the statistical models can only be checked relatively late in the development process, on the finished vehicle on a roller dynamometer.

One object is therefore to describe a method and a device using which more accurate, earlier, and less complex modeling of a warming-up behavior of a vehicle component is possible. In addition, a method and a vehicle are to be provided which enable improved monitoring of such warming-up behavior. Moreover, a computer program for improved modeling and improved monitoring of such a warming-up behavior is to be provided.

### SUMMARY

The above-described objects, as well as others, are achieved by the features of at least some embodiments disclosed herein.

A first aspect is a method for modeling a warming-up behavior of a vehicle component that includes a number of steps. A first step is detecting a plurality of input variables and warming-up curves during a plurality of warming-up processes of the vehicle component. Another step is creating a white box model based on items of information with respect to at least one of the plurality of input variables. A third step is training and validating a black box model based on items of information comprising at least one output variable of the white box model and at least one of the warming-up curves. A further step is modeling a warming-up behavior of the vehicle component by means of a gray box model consisting of the white box model and the black box model.

The input variables are, for example, measured values, such as temperatures or performances in or on the vehicle. One example of such an input variable is, for example, an internal performance of an engine. The input variables are detected as time curves during the plurality of the warming-up processes of the vehicle component. The warming-up curves are measured temperature curves of the vehicle component itself or a corresponding representative measured value, such as a temperature curve of a cooling circuit of the vehicle component.

A warming-up process describes the warming-up of the vehicle component from a starting temperature to an end temperature. Room temperature can be used as the starting temperature, for example, an operating temperature of the vehicle component which is reached during standard use of the component can be used as the end temperature, for example. One warming-up curve (for example the component temperature) can be detected per warming-up process, or multiple warming-up curves can be detected (for example, additionally to the current component temperature also a recursive observation of the component temperature).

Using the white box model, inputs for the black box model are simulated so that the black box model is supplied with optimized inputs. The inputs for the black box model which are to be simulated in this case comprise, for example, a part of the plurality of input variables which were previously detected. The items of information with respect to the at least one input variable, on the basis of which the white box model has been created, comprise, for example, physical boundary conditions with respect to the input variables, such as relationships between different ones of the detected input variables. The white box model is used for direct modeling of the system by way of, for example, a mathematical description of the system.

Thus, in the white box model, for example, a relationship can be established between a value with respect to a rotary actuator of a cooling circuit and a coolant pump, which is in turn dependent on an engine speed. The interconnection of such computation blocks represents the white box model. The white box model is used to compute the output variables of the white box model based on the input variables provided to the white box model as the input for the black box model, so that variables which are used as the input for the black box model have as few interactions as possible with one another. In this way, items of information about the relationships and dependencies of the input variables are supplied to the black box model without these items of information having to be stored in the black box model itself.

The black box model consists of a weighted combination of special basic functions. Measurement which were collected for the system to be modeled form the foundation of the modeling of the black box model. The black box model is used to compute a model of the warming-up behavior of the vehicle component on the basis of the detected input variables and warming-up curves prepared by means of the white box model and optionally additionally direct detected input variables provided to the black box model. Since interactions in the detected warming-up curves are reduced or canceled out by means of the white box model, the black box model can be supplied with items of information with respect to this warming-up curve which have no or hardly any interactions with one another. More accurate training of the black box model is possible in this way. The black box model is used for modeling on the basis of measurement data of the system to be modeled by means of connecting the white box model upstream. A training algorithm in the form of a neural network learns the system behavior in the black box model on the basis of the measurement data.

The black box model, which is based on a neural network, is trained and validated on the basis of the plurality of input variables and warming-up curves which were detected during a plurality of warming-up processes. For this purpose, the warming-up curves and input variables of the various warming-up processes of the vehicle component are supplied to the neural network of the black box model, at least partially by means of connecting the white box model upstream, and the black box model is trained and validated on the basis of these items of information. Warming-up processes modeled on the basis of the input variables are compared to the detected warming-up curves in order to thus train the black box model. During the training and validation, it is also possible to adapt the white box model further in order to achieve improved results in the modeling.

The gray box model, which consists of the linkage of the white box model with the black box model, can then model the warming-up behavior of the vehicle component. For this purpose, detected input variables are used analogously to those by means of which the black box model was trained and validated. In other words, optimized inputs for the black box model are generated by means of the white box model from the input variables, on the basis of which-and optionally direct input variables-the warming-up behavior of the vehicle component is modeled. Additionally, for test purposes, an approximation quality of the model can be assessed in order if necessary to perform further improvements of the white box model or further training and validating of the black box model.

One advantage in this case is that such a model of the warming-up behavior can be created significantly more accurately and quickly than the above-described statistical models allow this. In addition, it is already possible to perform the modeling very early in the development process, for example, on a component test bench (for example, an engine test bench).

A further advantage in this case is that the architecture made up of white box model and black box model enables simple adaptation of the modeling system to changed environmental conditions. If a vehicle component for which, for example, such a warming-up behavior has already been modeled is installed in a different vehicle type, but the physical framework conditions of the detected input variables are not or are not significantly changed in this way, the white box model can be adopted completely or at least partially unchanged and only the black box model can be retrained. Adaptations of the white box model for improved results are obviously also possible. Such an adapted gray box model, in which the white box model was completely or partially adopted and the black box model was retrained using the partially or completely adopted white box model connected upstream, can in turn model the warming-up behavior of the vehicle component with very high accuracy and reliability.

According to at least one embodiment, the black box model is based on a local linear model tree model (LoLiMOT model). The LoLiMOT model is a model which is based on a neural network. It is capable of learning any type of nonlinear relationship. In comparison to a classic neural network, the LoLiMOT model offers the advantage that it can be trained comparatively quickly and is reproducible quickly and without great expenditure.

The LoLiMOT model additionally has a deterministic learning phase in which linearizations of the input variables are performed in sections in order to be able to depict a system as accurately as possible. Additionally to the linearization in sections, weighting functions are used in order to link the linear sections. These linearizations in sections are performed in multiple dimensions, wherein each dimension corresponds to one input variable.

The LoLiMOT model is suitable in particular here for use in the black box model since in this way rapid training and additionally training on the basis of comparatively little training data is possible.

According to at least one embodiment, to detect the plurality of input variables and warming-up curves, at least a part of the plurality of the warming-up processes are generated by means of generic driving profiles on a vehicle test bench and/or at least a part of the plurality of the warming-up processes are generated by means of real actual driving profiles. One advantage in this case is that with input variables and warming-up curves which are detected by means of the generic driving profiles on a vehicle test bench, optimum conditions can be used for detecting the input variables and warming-up curves. In the case of input variables and warming-up curves which are detected by means of real actual driving profiles, for example, when driving the vehicle under normal usage conditions, there is the advantage that in this way realistic values can be detected, as would occur during standard use of the vehicle.

In at least one embodiment, at least a part of the generic driving profiles is created using a Markov approach and/or at least a part of the generic driving profiles is created using an amplitude modulated pseudorandom binary signal approach (APBRS approach). One advantage of the driving profiles which are generated by means of a Markov approach is that real driving profiles can be simulated. One advantage of the APRBS approach for generating the generic driving profiles is that an entire operating range can be covered.

In the driving profiles of both approaches, operating points are specified, for example, by means of Sobol sequences, which are followed for each warming-up process during which the plurality of input variables and warming-up curves are detected. Markov and APRBS approach describe the sequence between these operating points. In the Markov approach, transition probabilities of the Markov chain are used to describe the change of the operating points. If, for example, the warming-up behavior of a vehicle engine is to be modeled, these operating points thus comprise, for example, an engine speed and an engine torque which are set in various configurations during a warming-up process. The operating points optionally comprise in addition, for example, an item of information with respect to a position of a rotary actuator of a cooling circuit, which is varied while passing through various engine speed and engine torque operating points.

According to at least one embodiment, the plurality of input variables comprises at least one of the following input variables: an internal performance of the vehicle component; a component temperature of the vehicle component; an exhaust gas temperature of the vehicle component; an item of information with respect to a rotary actuator of a cooling circuit of the vehicle component; and an engine speed of the vehicle component.

Suitable input variables can be selected depending on the vehicle component for which the warming-up behavior is to be modeled. The input variables mentioned here are suitable in particular, for example, for modeling a warming-up behavior of a vehicle engine.

A second aspect is a device for modeling a warming-up behavior of a vehicle component comprises at least one sensor and one processor. The at least one sensor is configured to detect a plurality of input variables and warming-up curves during a plurality of warming-up processes of the vehicle component. The processor is configured to create a white box model based on items of information with respect to at least one of the plurality of input variables, to train and validate a black box model based on items of information comprising at least one output variable of the white box model and at least one of the warming-up curves, and to model a warming-up behavior of the vehicle component by means of a gray box model consisting of the white box model and the black box model.

The at least one sensor is in this case, for example, a sensor of a vehicle itself, for example, an engine sensor. The processor is, for example, a processor of an external computer system. Alternatively, the processor can also be a processor of an onboard computer of a vehicle. Of course, it is also possible that different processors implement the above-mentioned subject matter. For example, the white box model is created and the black box model is trained and validated on an external computer system and the warming-up behavior is modeled by an onboard computer to which the gray box model is available.

A third aspect is a method for monitoring a warming-up behavior of a vehicle component that includes a number of steps. A first step is detecting the warming-up behavior of the vehicle component by means of at least one measured value during operation of the vehicle. Another step is checking the detected warming-up behavior by means of a modeled warming-up behavior, wherein the modeled warming-up behavior was created according to the method according to the first aspect.

One advantage in this case is that using this method, a warming-up behavior of the vehicle component can be monitored, for example, during a journey of the vehicle, on the basis of the above-described accurate and reliable model. Incorrect error messages are reduced and a user experience is thus improved using this method.

A fourth aspect is a vehicle comprises an OBD system for monitoring a warming-up behavior of a vehicle component, wherein the OBD system is configured to carry out the method according to the third aspect.

According to at least one exemplary embodiment, the vehicle component is an electric motor or an internal combustion engine of the vehicle. The monitoring system shown here is suitable in particular for such engines of a vehicle, since in particular in the case of engines an unusual warming-up behavior can be an indication of a malfunction. In this case, the at least one measured value by means of which the warming-up behavior of the vehicle component is detected comprises, for example, a coolant temperature of a coolant water and/or an oil.

A fifth aspect is a computer program comprises instructions which, when the program is executed by a computer, cause the computer to carry out the method according to the first or the third aspect. The computer program is stored on a computer-readable medium.

Optional embodiments of the first to fifth aspect can each also be provided in the other aspects and can have corresponding effects.

Exemplary embodiments are explained in more detail hereinafter on the basis of schematic drawings.

### BRIEF DESCRIPTION OF THE DRAWINGS

FIG. 1 shows a flow chart of a method for modeling a warming-up behavior of a vehicle component according to one exemplary embodiment,

FIG. 2 shows a device for modeling a warming-up behavior of a vehicle component according to one exemplary embodiment,

FIG. 3 shows a flow chart of a method for monitoring a warming-up behavior of a vehicle component according to one exemplary embodiment,

FIG. 4 shows a vehicle comprising an OBD system according to one exemplary embodiment,

FIG. 5 shows a schematic illustration of a gray box model according to one exemplary embodiment, and

FIG. 6 shows a flow chart of a method for modeling a warming-up behavior of a vehicle component according to a second exemplary embodiment.

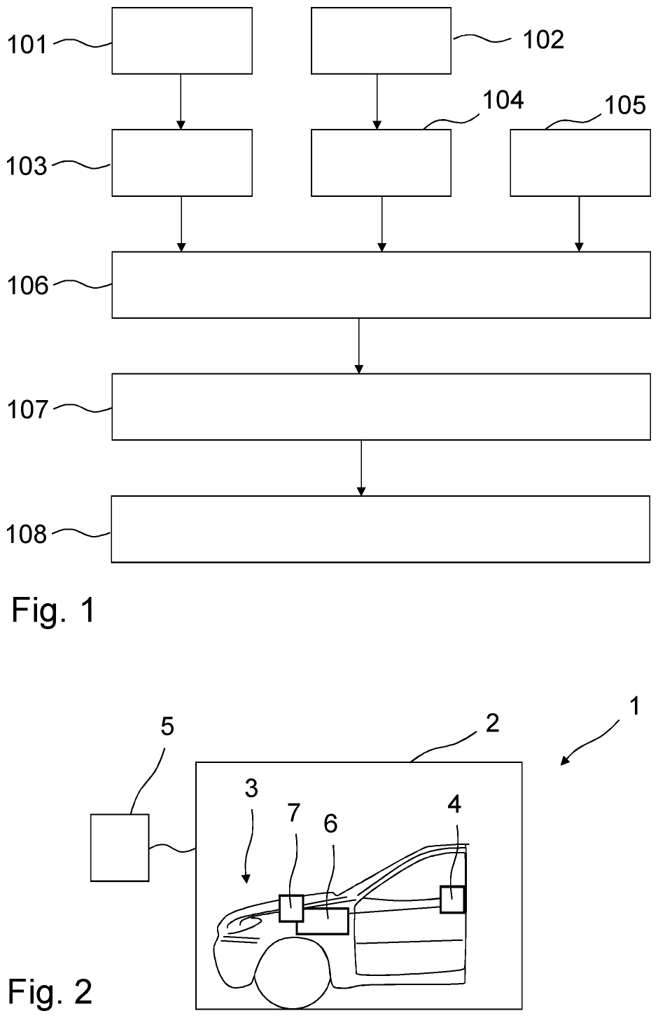

The method according to FIG. 1 will be described on the basis of an example in which the vehicle component is an engine of a vehicle. Alternatively, however, any other components of a vehicle can also be assumed here.

In a first step 101 of the method according to FIG. 1, generic driving profiles are created based on a Markov approach. In a second step 102, generic driving profiles are created based on an APRBS approach. In both steps 101 and 102, initially a plurality of operating points is generated by means of Sobol sequences, in the example shown here specified values for a speed and a torque of the engine, and the generic driving profiles are then determined by means of the Markov or the APRBS approach, by corresponding linking of the respective operating points.

In a third step 103, various input variables and warming-up curves are detected on the vehicle in a vehicle test bench, while the driving profile generated in step 101 is run through on the vehicle. The input variables are, for example, an internal performance of the engine and/or a position of a rotary actuator of a cooling circuit of the engine, the time curve of which is detected during the warming-up of the engine. The warming-up curve is, for example, a coolant temperature of the engine. In a fourth step 104, identical input variables and warming-up curves are detected analogously to step 103, while running through the driving profiles generated in step 102. In a fifth (optional) step 105, corresponding input variables and warming-up curves are detected during a journey of the vehicle on a road.

The detected input variables are in this exemplary embodiment an exhaust gas temperature, an internal performance, and a position of a rotary actuator of a cooling circuit of the engine, the time curve of which was detected during the warming-up of the engine, and an engine speed of the engine of the vehicle, which is specified on the basis of the operating points. The warming-up curve is, for example, the time curve of a coolant temperature of the engine. Alternatively or additionally, in particular if a warming-up behavior of another component is to be modeled, of course, additional or other input variables can also be used.

In a sixth step 106, a white box model is created with respect to a part of the above-described input variables. Mathematical and physical relationships between these input variables are stored in the white box model. In the exemplary embodiment shown here, for example, relationships between the internal performance of the engine, the rotary actuator of the cooling circuit, and the engine speed are mapped. In this way, the input variables detected in steps 103 to 105 are simulated so that they can be optimally used for the further method.

In a seventh step 107, a black box model, which is based on a LoLiMOT model in the exemplary embodiment shown here, is trained and validated on the basis of the input variables and warming-up curves detected in steps 103 to 105. For this purpose, specific input variables, in the exemplary embodiment shown here a component temperature and an exhaust gas temperature, are transferred directly to the LoLiMOT model. The internal performance, the position of the rotary actuator, and the engine speed are fed to the LoLiMOT model in the form as they were simulated by the white box model for the black box model, thus the output variables of the white box model. The result is compared to the detected warming-up curves for validation.

The LoLiMOT model supplies good results if the input variables which were fed to the LoLiMOT model are as independent as possible of one another. Since different ones of the input variables detected here are dependent on one another, the white box model is used to link the dependencies of the detected input variables with one another so that output variables of the white box model are generated for the LoLiMOT model, which are independent of one another.

In an eighth step 108, a warming-up behavior of the engine of the vehicle is modeled using a gray box model, which consists of the above-described white box model and This modeling takes place, the black box model. analogously to the training and validating, based on detected input variables. For example, 60% of the input variables and warming-up processes detected in steps 103 to 105 can be used for training, 20% for validating, and a further 20% for the final modeling of the warming-up behavior. The modeled warming-up behavior can be checked once again using an actual warming-up process for test purposes in order to determine an approximation quality. If the approximation quality is adequate, the warming-up behavior modeled in step 108 is used as the model. If it is established that an improvement of the approximation quality is desired, the white box model can be adapted and steps 107 and 108, i.e., training and validating and modeling the warming-up behavior can be repeated.

The modeled warming-up process of the engine generated here in step 108 thus supplies a model of the warming-up behavior which can supply a high level of accuracy and reliability.

FIG. 2 shows a device 1 for modeling a warming-up behavior of a vehicle component. The device 1 is suitable in particular for carrying out steps 103 to 108 of the method according to FIG. 1. Optionally, steps 101 to 102 can also be carried out using the device 1 according to FIG. 2.

The device 1 comprises a vehicle test bench 2 in which a motor vehicle 3 is located. The vehicle test bench 2 is connected to a computer 5. The computer 5 can be, for example, a local computer or a computer which is connected via a network to the vehicle test bench 2.

The motor vehicle 3 has an engine 6 for which a warming-up behavior is to be modeled. The engine 6 is, for example, an internal combustion engine or an electric motor. The motor vehicle 3 furthermore has an onboard computer 4. The motor vehicle 3 furthermore has a sensor 7 which is, for example, a sensor of an OBD system, for example, an engine sensor. The sensor 7 is configured to detect a plurality of input variables and warming-up curves, for example, the warming-up curves and input variables described with reference to FIG. 1, during a plurality of warming-up processes of the engine 6.

The computer 5 has a processor (not shown here), which is configured to create a white box model based on items of information with respect to at least one of the plurality of input variables. The processor of the computer 5 is furthermore configured to train and validate a black box model based on items of information comprising at least one output variable of the white box model and at least one of the warming-up curves. The onboard computer 4 also comprises a processor (not shown here), which is configured to model a warming-up behavior of the engine 6 by means of a gray box model consisting of the white box model and the black box model.

The creation of the white box model, the training of the black box model, and the modeling of the warming-up behavior can be carried out, for example, according to steps 106 to 108 according to FIG. 1. The processor of the computer 5 can furthermore be configured to generate the driving profiles according to steps 101 and 102 according to FIG. 1.

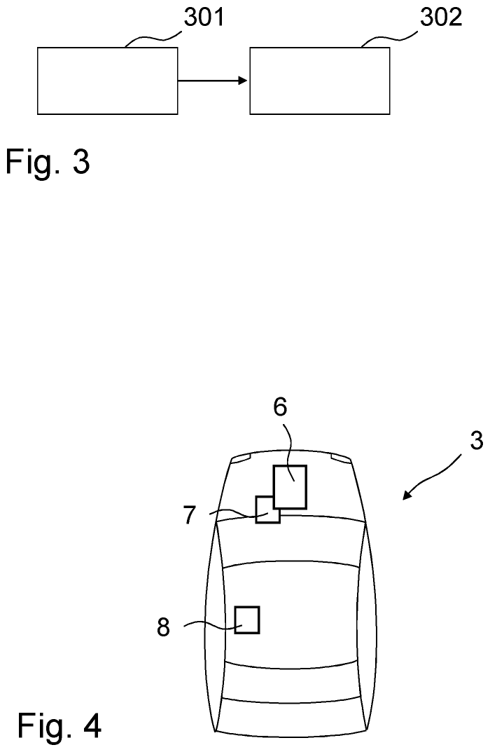

FIG. 3 shows a flow chart of a method for monitoring a warming-up behavior of a vehicle component. FIG. 3 will be described analogously to FIGS. 1 and 2 by way of example with respect to a warming-up behavior of an engine of a vehicle.

In a first step 301, a warming-up behavior of the engine is detected by means of at least one measured value during operation of the vehicle. To monitor the warming-up behavior of the engine, for example, in first step 301, a temperature of a coolant of the engine is detected.

In a second step 302, the detected warming-up behavior of the engine is checked on the basis of a modeled warming-up behavior, wherein the modeled warming-up behavior was created corresponding to the method according to FIG. 1.

FIG. 4 shows a schematic illustration of a vehicle 3 for monitoring a warming-up behavior of a vehicle component, described here by way of example with respect to the warming-up behavior of an engine 6.

The vehicle shown here is, for example, the motor vehicle 3 according to FIG. 2. The motor vehicle 3 also comprises the engine 6 here, the warming-up behavior of which is to be monitored, and the sensor 7. Furthermore, an OBD system 8 is shown in the motor vehicle 3 here, the software of which runs, for example, on an onboard computer, such as the onboard computer 3 according to FIG. 2. The OBD system 8 is configured to detect a warming-up behavior of the engine 6 by means of a measured value, measured using the sensor 7, and to check the detected warming-up behavior by means of a modeled warming-up behavior, wherein the modeled warming-up behavior was created corresponding to the method according to FIG. 1.

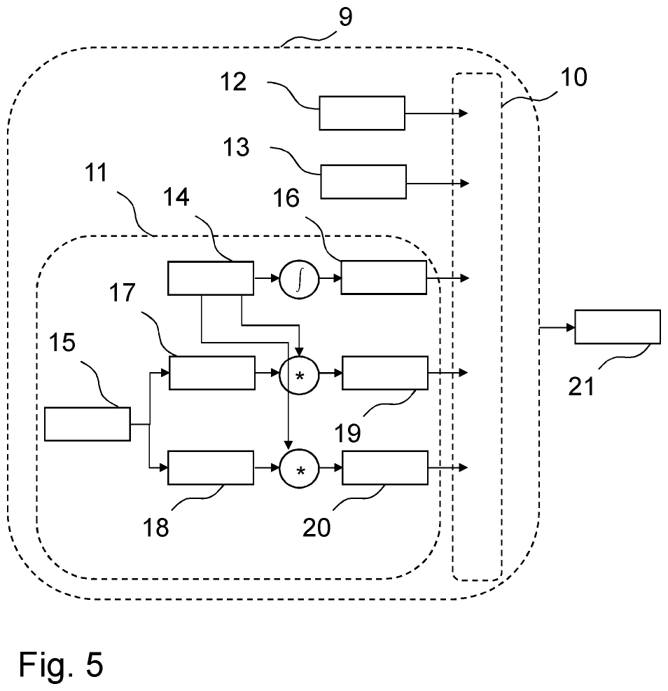

FIG. 5 shows a schematic and very simplified illustration of a gray box model 9 according to an exemplary embodiment. The gray box model 9 comprises a black box model 10 and a white box model 11. Input variables 12, 13, 14, 15 are fed to the black box model 10, which is, for example, a LoLiMOT model. The input variable 11 in this example describes a component temperature, the input variable 13 in this example describes an exhaust gas temperature, the input variable 14 in this example describes an internal performance, the input variable 15 in this example describes a position of a rotary actuator of a heating circuit. The input variables 12, 13, 14, 15 are detected, for example, as described in FIGS. 1 to 4.

The component temperature 12 and the exhaust gas temperature 13 are fed directly to the black box model 10. The internal performance 14 and the position of the rotary actuator 15 are simulated in the white box model 11 in order to generate optimized output variables of the white box model as the input for the black box model 10 from these input variables 14, 15.

The internal performance 14 is integrated so that the result, the integrated internal performance 16, can be fed to the black box model 10.

The position of the rotary actuator 15 comprises, on the one hand, a first rotary actuator characteristic curve 17 of a first cooling circuit, and a second rotary actuator characteristic curve 18 of a second cooling circuit. These rotary actuator characteristic curves 17, 18 are each multiplied by the internal performance 14, so that heat flows 19, 20 of the respective cooling circuits are computed. These heat flows 19, 20 are then fed to the black box model 10. The white box model 11 can of course comprise and link additional computation steps and further input variables.

The black box model 10 then models, on the basis of the direct input variables 12, 13 and the input variables 14, 15 modified via the white box model 11, the model 21 of the warming-up behavior of the component to be studied.

Features which are described with respect to one of FIGS. 1 to 6 can of course also be used similarly in the exemplary embodiments of the other figures.

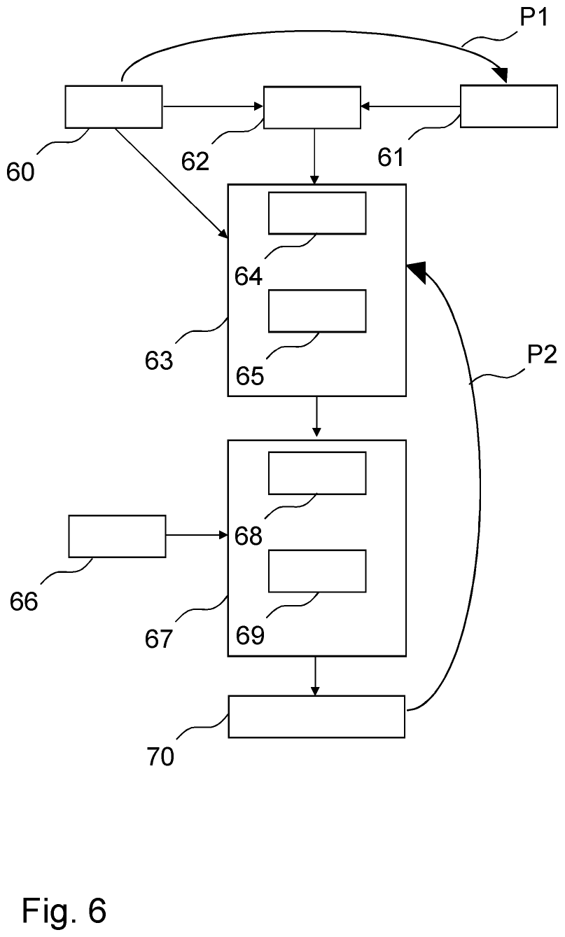

FIG. 6 shows a flow chart of a method for modeling a warming-up behavior of a vehicle component according to a second exemplary embodiment.

A system analysis is carried out in a step 60, in which it is determined which items of information are relevant for the modeling of the warming-up behavior of the vehicle component.

In a step 61, a design of experiments (DOE) is carried out. In this step, it is determined in which way the items of information determined in step 60 can be detected. This is indicated by arrow Pl. For example, operating points are defined and methods for generating driving profiles are determined.

In a step 62, training data are generated. For this purpose, a plurality of input variables and warming-up curves is detected.

In a step 63, a gray box model is created. For this purpose, a white box model is created in a substep 64, for which physical framework conditions are used, for example, obtained from the system analysis in step 60. In a further substep 65, a black box model is trained and validated based on output variables of the white box model and the training data detected in step 62. During the training and validating in step 62, it is also possible to further adapt the white box model in order to achieve more accurate results.

In a further step 66, previously unused training data are fed to the trained and validated system.

In a step 67, a warming-up behavior of the vehicle component is computed using the gray box model, i.e., the black box model and white box model connected upstream, as a test on the basis of the training data fed in step 66.

For this purpose, analogously to the training and validating, input variables are simulated using the white box model in a substep 68 and these simulated output variables are fed to the black box model in a substep 69 in order to compute the warming-up behavior.

In a further step 70, an approximation quality of the computed model is determined. If this is adequate, the computed model is used as the model of the warming-up behavior, for example, to be stored in an OBD system for diagnostic purposes. If the approximation quality is not adequate, the system is trained and validated again as indicated by means of arrow P2. This can be repeated arbitrarily often until a desired approximation quality is achieved.

### List of Reference Signs

1 device
2 vehicle test bench
3 motor vehicle
4 onboard computer
5 computer
6 engine
7 sensor
8 OBD system
9 gray box model
10 black box model
11 white box model
12 component temperature
13 exhaust gas temperature
14 internal performance
15 position of a rotary actuator
16 integrated internal performance
17 first rotary actuator characteristic curve
18 second rotary actuator characteristic curve
19 heat flow of the first cooling circuit
20 heat flow of the second cooling circuit
21 model of the warming-up behavior
101 to 108 steps
301 to 302 steps
60 to 70 steps
P1, P2 arrow

1-10. (canceled).

11. A method for modeling a warming-up behavior of a vehicle component, the method comprising:
detecting a plurality of input variables and obtaining warming-up curves during a plurality of warming-up processes of the vehicle component;
creating a white box model based on items of information with respect to at least one of the plurality of input variables;
training and validating a black box model based on items of information comprising at least one output variable of the white box model and at least one of the warming-up curves;
modeling a warming-up behavior of the vehicle component using a gray box model formed of the white box model and the black box model.

12. The method as claimed in claim 11, wherein the black box model is based on a local linear model tree model (LoLiMOT model).

13. The method as claimed in claim 11, wherein detecting the plurality of input variables and obtaining warming-up curves includes generating the plurality of warming-up processes using generic driving profiles on a vehicle test bench.

14. The method as claimed in claim 13, wherein detecting the plurality of input variables and obtaining warming-up curves includes generating the plurality of warming-up processes using real actual driving profiles.

15. The method as claimed in claim 13, wherein at least a part of the generic driving profiles is created using a Markov approach.

16. The method as claimed in claim 13, wherein at least a part of the generic driving profiles is created using an amplitude modulated pseudorandom binary signal approach (APRBS approach).

17. The method as claimed in claim 11, wherein detecting the plurality of input variables and obtaining warming-up curves includes generating the plurality of warming-up processes using real actual driving profiles.

18. The method as claimed in claim 11, wherein the plurality of input variables comprises at least one of the following input variables:
an internal performance of the vehicle component,
a component temperature of the vehicle component,
an exhaust gas temperature of the vehicle component,
an item of information with respect to a rotary actuator of a cooling circuit of the vehicle component, and
an engine speed of the vehicle component.

19. The method as claimed in claim 18, wherein detecting the plurality of input variables and obtaining warming-up curves includes generating the plurality of warming-up processes using generic driving profiles on a vehicle test bench.

20. The method as claimed in claim 18, wherein detecting the plurality of input variables and obtaining warming-up curves includes generating the plurality of warming-up processes using real actual driving profiles.

21. A method for monitoring a warming-up behavior of a vehicle component of a vehicle, the method comprising:
detecting the warming-up behavior of the vehicle component using at least one measured value during operation of the vehicle; and
checking the detected warming-up behavior by means of a modeled warming-up behavior, wherein the modeled warming-up behavior created according to the method as claimed in claim 11.

22. A vehicle comprising an onboard diagnostic system (OBD system) for monitoring a warming-up behavior of a vehicle component, wherein the OBD system is configured to carry out the method as claimed in claim 21.

23. The vehicle as claimed in claim 22, wherein the vehicle component is an electric motor or an internal combustion engine of the vehicle.

24. A computer-readable medium comprising instructions which, when the program is executed by a computer, cause the computer to carry out the method as claimed in claim 11.

25. A computer-readable medium comprising instructions which, when the program is executed by a computer, cause the computer to carry out the method as claimed in claim 21.

26. A device for modeling a warming-up behavior of a vehicle component, the device comprising at least one sensor and one processor, wherein:
the at least one sensor is configured to detect a plurality of input variables and obtain warming-up curves during a plurality of warming-up processes of the vehicle component; and
the processor is configured to create a white box model based on items of information with respect to at least one of the plurality of input variables, to train and validate a black box model based on items of information comprising at least one output variable of the white box model and at least one of the warming-up curves, and to model a warming-up behavior of the vehicle component using a gray box model formed of the white box model and the black box model.
